(19) United States
(12) Patent Application Publication
(10) Pub. No.: US 2021/0203733 A1
(43) Pub. Date: Jul. 1, 2021

(54) Automated Constrained Datamodel Provisioning Procedure

(71) Applicant: Telefonaktiebolaget LM Ericsson (publ), Stockholm (SE)

(72) Inventors: Veikko Oittinen, Kirkkonummi (FI); Ari Keränen, Helsinki (FI); Davide Piscopo, Helsinki (FI)

(21) Appl. No.: 17/253,732

(22) PCT Filed: Jun. 26, 2018
(86) PCT No.: PCT/EP2018/067103

§ 371 Date: Dec. 18, 2020

(51) Int. Cl. H04L 29/08; H04W 4/70

(52) U.S. Cl. CPC H04L 67/16; G16Y 30/00; H04W 4/70

(57) ABSTRACT

According to an aspect, communications device (e.g., IoT device) is configured to allow attachment of one or more peripheral devices. The communications device detects attachment of a peripheral device and obtains a template description file for the peripheral device. The template description file includes one or more service descriptions corresponding to respective exposed peripheral services, where each service description includes one or more peripheral-specific operations. The communications device receives, from a network-based application, a query directed to the peripheral device, the query requesting one of the exposed peripheral services. The communications device executes the peripheral-specific operations from the service description corresponding to the requested one of the exposed peripheral services and responds to the network-based application with a result of the peripheral-specific operations.

### TECHNICAL FIELD

The present disclosure generally relates to the field of wireless network communications, and more particularly, to the management and use of hardware peripherals for Internet-of-Things (IOT) devices.

### BACKGROUND

For a fully interoperable Internet-of-Things (IoT) system, the IoT device, which may be a networked device equipped with any of a variety of sensors and/or data collectors, and an IoT controller, which may be an application that communicates with the IoT device through the network, e.g., through a wireless network, need to use the same data model for communicating, or a data model that can be automatically translated from one to another.

Standards for communicating with IoT devices have been developed, such as the IPSO Smart Objects Guidelines available from OMA SpecWorks, which describe a common object model based upon the Lightweight M2M 1.0 specifications developed by the Open Mobile Alliance (OMA). These provide device management and service architecture specifications, based on the IETF CoAP protocol, and provide an object model for constrained device management. The goal of these and other efforts is to provide for high-level interoperability between IoT devices and connected applications on other devices or platforms.

However, certain obstacles to providing interoperability for newly developed sensors and data collectors remain. The techniques described herein address some of these obstacles.

### SUMMARY

The communication and processing functions of an IoT device may be provided in a device, e.g., a wireless M2M device, that allows any of a wide variety of sensors, data collectors, actuators to be connected to it as a peripheral, e.g., when the device is installed in the field. When a new sensor is added as a peripheral to one of these IoT devices, however, the semantics and data structures of the data model needed for proper communication with the peripheral are often different from existing data models. The various methods and apparatus described herein may be used to address this problem.

Embodiments of the present invention enable plug and play sensor and actuator addition functionality end-to-end from sensor to IoT platform.

According to some embodiments, a method, in a communications device configured to allow attachment of one or more peripheral devices includes detecting attachment of a peripheral device and obtaining a template description file for the peripheral device, the template description file comprising one or more service descriptions corresponding to respective exposed peripheral services, each service description comprising one or more peripheral-specific operations. The method also includes receiving, from a network-based application, a query directed to the peripheral device, the query requesting one of the exposed peripheral services. The method further includes executing the one or more peripheral-specific operations from the service description corresponding to the requested one of the exposed peripheral services and responding to the network-based application with a result of the one or more peripheral-specific operations.

Further aspects of the present invention are directed to a communications device, computer program products or computer readable storage medium corresponding to the methods summarized above and functional implementations of the above-summarized communications device.

Advantages that can be realized using various embodiments described herein include that the IoT device can be simple, since it doesn't need to understand the specifics of the data model of the peripherals. The IoT device doesn't need to be manually updated every time a new sensors or actuator is connected to the device—instead, new peripherals can be added in plug-and-play fashion. Manufacturers will have access to a semantic standard to enable the addition of already existing hardware to the IoT scenario, at the cost of writing a file instead of developing additional hardware. Other advantages that arise from some of the embodiments disclosed herein include that a simple peripheral paired with a file at attachment time can enable authentication of the file provisioner, avoiding attacks on the channel between peripheral and the device.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE FIGURES

FIG. 1 illustrates an example IoT device with a Plug & Play Library, a peripheral and other entities, according to some embodiments.

FIG. 2 illustrates messaging between entities, according to some embodiments.

FIG. 3 illustrates a template retrieval for a peripheral, according to some embodiments.

FIG. 4 illustrates is a block diagram of a communication device, according to some embodiments.

FIG. 5 illustrates a flow diagram of a method for allowing attachment of one or more peripheral devices to the communication device, according to some embodiments.

FIG. 6 illustrates a functional implementation of a communication device, according to some embodiments.

### DETAILED DESCRIPTION OF EMBODIMENTS

Exemplary embodiments of the present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment can be tacitly assumed to be present/used in another embodiment.

When building an IoT system today, a substantial amount of expertise and time is needed for programming the IoT device platform to expose its capabilities in an interoperable way to the IoT applications, which may be run, for example, in the cloud. One flexible and cost-effective approach to providing IoT devices is to implement the communication and processing functions of the IoT device into a main device, e.g., a wireless M2M device, that allows any of a wide variety of sensors and/or data collectors to be connected to it as peripheral, e.g., when installed in the field. Thus, the main device can be designed, manufactured, and distributed separately from the peripheral data collection devices, which can be paired with the main device later, e.g., at deployment in the field. For instance, a wireless M2M device, which is an example of the “IoT devices” discussed herein, might be installed in a home or office as standard equipment, with a tenant later connecting one or more IoT peripherals, such as smart light bulbs, security cameras, proximity sensors, temperature sensors and thermostats, or the like. As another example, an IoT device might be designed and sold for general use in industrial process monitoring, with a specific customer adding separately obtained sensors and/or actuators that are appropriate for the customer's particular process.

However, when new sensors are added as peripherals to one of these IoT devices, the semantics and data structures of the data model needed for proper communications with the peripheral are often different from existing data models. This is an obstacle to rapid prototyping and deployment of new instruments, sensors, and data collection devices. In order to rapidly build and prototype with IoT systems, more automated capabilities are needed for the device platform, to allow immediate plugging in of new sensors and actuators that can immediately be used with applications. But, many of the existing standards or standards under development do not aim to enable what is already deployed or present in the market—instead they focus on solutions that need remanufacturing, re-provisioning and/or retesting of already working development platforms.

The various methods and apparatus described herein may be used to address this problem. It will be appreciated, upon review of the details described below, that the apparatuses and techniques not only permit the immediate installation and use of new sensors and actuators, but can also be implemented so as to allow these IoT peripherals to be connected without rebooting or shutting down the system—thus, for example, new security-related devices can be connected without interrupting ongoing monitoring.

The IEEE 1451.X family of standards for a smart transducer interface for sensors and actuators provides standards for building interoperable interfaces for sensor and actuators. It defines common functions, communication protocols and transducer electronic data sheet (TEDS) formats requiring the user of the standard to be hardware compliant with the components defined. Standards like this facilitate the development and use of new sensors and actuators that can be connected, for example, to existing M2M devices compliant to the same standards. As will be seen below, the IEEE 1451.X standards (or similar standards) may be used with the techniques and apparatus described herein.

As suggested above, there exist already data models for exchanging information between an IoT device and the IoT framework, such as the OMA IPSO Smart Object Guidelines. However, these data models do not address the problem of how the IoT device actually performs the desired operation on a given sensor, transducer, or other data collection device.

The techniques described herein allow these transducer/sensor/data-collection-device-specific operations to be mapped to the standardized data model for communications over a network. In various embodiments as described herein, the IoT device retrieves these mappings from a file, referred to herein as a “template description file,” provided to the IoT device, where the template description file specifically corresponds to a particular type of transducer, sensor, or other data collection device. As described in much more detail below, the template description file, which may be retrieved from memory in the transducer/sensor/data-collection device itself or from another source, such as from a network resource identified by a Uniform Resource Identifier (URI) stored in the transducer/sensor/data-collection device, contains a service description and, in some cases, a template answer, corresponding to a standardized IoT command, service, or resource, such that the IoT Device can perform peripheral-specific operations to execute the service, fill the template answer with a resulting value or values, and respond to a standardized query, independently of any formats or operations that are specific to and/or unique to the transducer/sensor/data-collection device. Thus, on request from an IoT controller, which might reside in the cloud, for example, the IoT device reads from the template which standardized operation is requested, executes the operation using hardware-specific semantics in the corresponding service description included in the template description file, fills the result value or values into a template answer included in the template description file, to obtain a response message, and sends the resulting response message to the IoT controller.

For convenience, these sensors, transducers, and other data collection devices will be referred to as “peripheral devices” herein. Likewise, commands, functions, operations, and the like that are specific to the use of these sensors, transducers, and other data collection devices are referred to herein as “peripheral-specific operations,” or the like. However, it should be understood that the techniques described herein do not depend on these peripheral devices taking any particular physical form. For instance, while these peripheral devices may be designed for simple connection and disconnection from a primary IoT device, such as via a standardized connector interface, this is not a requirement for enjoying the benefits of the presently disclosed techniques.

Correspondingly, the term “exposed peripheral services” is used herein to refer to resources, commands, functions, operations, and the like, that are made available to an IoT application, e.g., an IoT controller, by an IoT device. These exposed peripheral services may be, for example, standardized commands or queries according to standards such as those available from OMA SpecWorks, the Open Connectivity Foundation (OCF), the Web of Things Working Group of W3C, and the Fairhair Alliance, but are not necessarily so.

Finally, the term “service description” is used herein to refer to the semantics, in a template description file, defining the peripheral-specific operations corresponding to an exposed peripheral service. A given service description may include one or more template answer, for use in constructing a response message for sending back to the network-based application in response to the query for the exposed peripheral service. However, it will be appreciated that not all exposed peripheral services require a response, and thus not all service descriptions will include such an answer template.

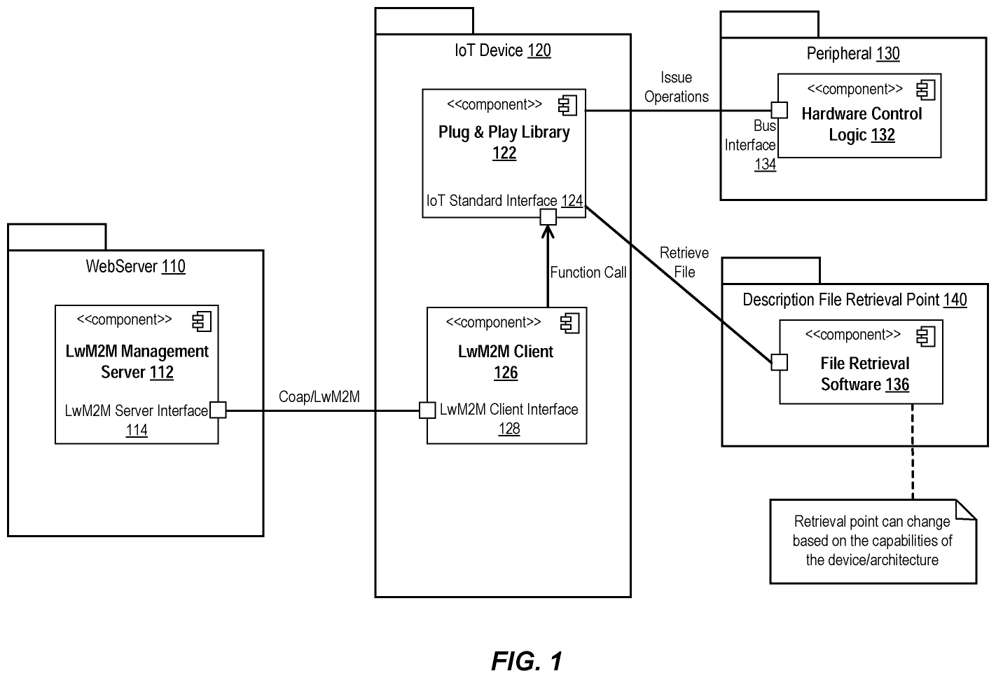

FIG. 1 illustrates an example IoT system incorporating some of the techniques and apparatus detailed herein. The illustrated system includes a web server 110, which includes an LwM2M management server 112, which may be considered an example of an IoT application, or IoT controller. The system further includes an IoT device 120, which may be a wired or wireless communication device, such as an M2M device. IoT device 120 includes an LwM2M client 126, which communicates with the LwM2M management server 112 via an LwM2M client interface 128 (in the IoT device 120) and an LwM2M server interface 114 (in the web server 110). In this example, the communications between these devices is according to the LwM2M and CoAP standards/protocols. However, it should be understood that the illustrated use of LwM2M is just an example—other standards and/or protocols, whether existing, under development, or not yet developed, may be used.

The system shown in FIG. 1 further includes a peripheral 130, which includes hardware providing an actuator, a sensor, a transducer, or some other data collection functional, whether alone or in some combination. In some embodiments, peripheral 130 may be physically separable from the IoT device, such that it may be connected and disconnected via a standardized connector that provides connectivity to internal hardware control logic 132 via a bus interface 134, for instance. In some embodiments, peripheral 130 may not be physically connected to IoT device 120, but communicatively connected via short-range wireless technology, such as Bluetooth® or Zigbee technology. In either case, the connectivity between IoT device 120 and hardware control logic 132 may be provided via a standardized communications interface. However, the specific commands and operations for controlling and/or querying the peripheral device 130 may be peripheral-specific, i.e., specific to the type and/or make of the peripheral device 130.

The plug-and-play functionality provided by several of the embodiments disclosed herein utilizes three components: a software component running on the IoT device 120, illustrated in FIG. 1 as a “plug and play library” 122, a template description file, paired with the peripheral device 130, and a file storage. As discussed in further detail below, the software queries the template description file to determine how to respond to standardized queries received by the IoT device 120 from the web server 110. A template description file entry point 140 is defined during the one-time-per-technology configuration of the software component running on the IoT Device.

The template description file, in some embodiments, is initially stored in memory in the peripheral 130, and retrieved by the plug and library component 122, e.g., using file retrieval software 136. In other embodiments, the template description file may be supplied to the plug and play library 122 separately. In some embodiments, a uniform resource identifier (URI) may be stored in the peripheral 130, retrieved by plug and play library 122, and then used by file retrieval software 136 to download the template description file from the internet.

The template description file contains semantic information defining “how” to access the peripheral to carry out a given service or operation and, in some embodiments and/or instances, a service description describing “what” operation needs to be executed in order to respond to an IoT Controller with the data produced by the peripheral (in the case of a read operation). Here, this semantic information corresponding to a given service or operation is referred to as a “service description.” The description file thus includes semantic descriptions of the peripheral's various peripheral-specific operations and their mappings to a data model (e.g., an IPSO object), and information on “how” to retrieve that data from the sensor (e.g., a LwM2M read Operation).

The systems described herein may support cooperating functionalities, whether within a single peripheral or among two or more separate peripheral devices connected to the same IoT device.

These locally cooperating functionalities can be exposed in a transparent way to the system—using one cooperating functionality doesn't require that the end user even know that this functionality collaborates with another functionality provided by the peripheral/bundle. Thus, it is possible to design specific sets of physical hardware, i.e., distinct peripherals or bundles, that may cooperate outside of their local scopes, if a compatible cooperating peripheral or bundle is present, but still within the scope of the designed set. Accordingly, a peripheral vendor with a large set of peripherals on the market may design those peripherals to cooperate with others provided by the same vendor, such that these peripherals provide added value when used with others of the same brand.

Upon an attachment event, which may be detected by various means, such as by a manually operated push button on the IoT device, or via automatic detection of a connector coupling, or via near-field communications (NFC) detection, the software component running on the IoT device retrieves the template description file. In some embodiments, the software component “compiles” the hardware operation or operations described in the template description file with the actual physical addresses of the transducer, which may be determined at attachment time. After compiling the file, the software stores the compiled version to the file storage to keep a state of the already attached peripherals. Doing so ensures consistency between the software model and the hardware configuration, providing robustness to crashes and reboots. After each “compile” operation, the software may keep track of the already “in use” addresses, to facilitate the subsequent attachment of one or more additional peripherals. Under the assumption that the peripherals are attached one at a time, keeping track of the in-use addresses is key to enable dynamic attachment.

In some embodiments, the software component offers interfaces to execute integrity and authentication checks on the template description files provided with or corresponding to the peripherals. This may be done using certificates stored in the IoT device 120, for example, or via network communications with a trusted server. If the IoT domain requires this type of check, depending on the IoT device's capabilities, such interfaces can be implemented. The implementation is needed once per technology in order to better fit the specific hardware capabilities (e.g., taking full advantage of an included cryptographic unit, if any) or domain-specific requirements. In these embodiments, on the attachment of a new peripheral 130, the software component will check the integrity of the description file and, in some embodiments, may verify the identity of the user who is attaching it. The template description file may provide a special label to store the user's key, in order to authenticate it.

If any integrity and authentication checks that are performed are passed, the software component continues with the normal flow of operations to identify and attach the new peripheral 130 to the system. If these integrity and authentication interfaces are not defined, the integrity and security checks are skipped, and the software component starts the identification and attachment procedures.

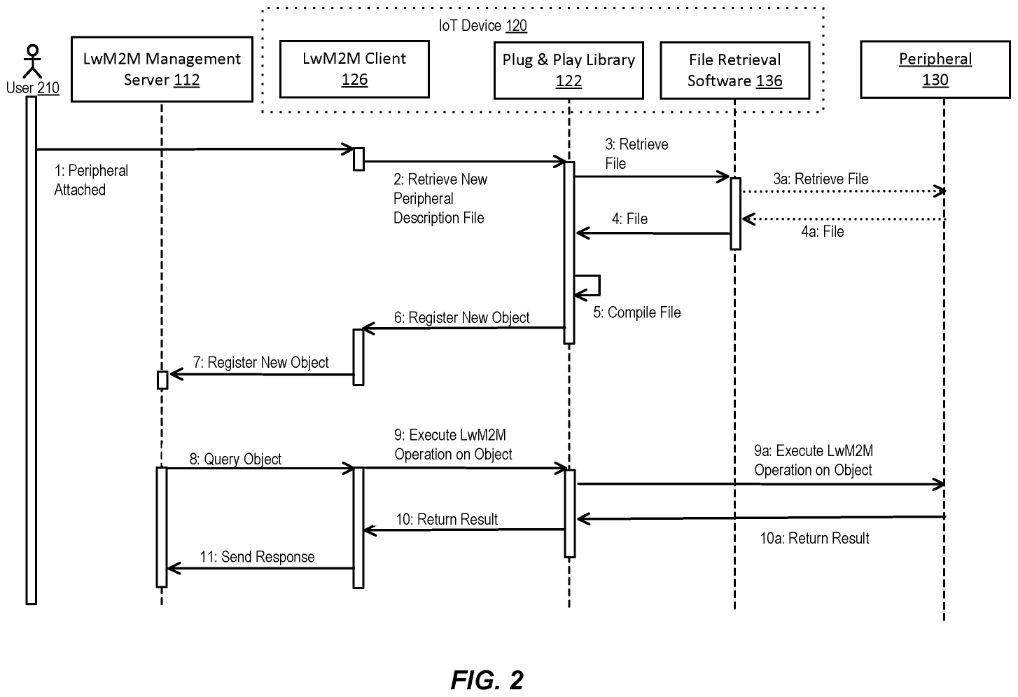

FIG. 2 is a flow diagram that illustrates how a peripheral device 130, such as a temperature sensor, is connected to an IoT device (LwM2M client), detected, and exposed to a LwM2M Management Server 112 (i.e., a network-based application). As shown at step 1, the peripheral device 130 is connected to the device. The attachment of the peripheral device 130 may comprise connecting a temperature sensor to the IoT device 120 via an I2C bus, for example.

The IoT device 120 is running the software component for enabling automated constrained data model provisioning, as well as the software needed to enable network communication (operating system and network stack).

In the illustrated example, the software component shown as plug and play library 122 is pre-configured to retrieve the template description file of the attached peripheral 130 from the address “1010000” of the I2C bus, using the file retrieval software 136. In the template description file there are service descriptions, which include address-independent descriptions of the peripheral-specific hardware operations corresponding to each of one or more exposed peripheral services and, in some instances, a corresponding template answer.

Returning to FIG. 2, at step 1, the IoT device 120 is running and the attachment event is triggered. Depending on the technologies supported by the IoT device 120, an attachment event can be configured to be, e.g., a button press, an NFC scan, or something else. At steps 2, 3, and 4, the IoT 120 device retrieves the template description file, e.g., by using address “1010000” for the bus/protocol used by the new attached peripheral 130, and scans the bus for new addresses. As discussed above, in some embodiments the template description file may be retrieved from memory in the peripheral device 130 itself. In FIG. 2, this is shown at steps 3a and 4a. In other embodiments, the template description file might instead be retrieved from the network or from an attached computer or accessor device. Note that in the illustrated example, the IoT device's functionality is divided between an LwM2M client 126, a plug and play library component 122, and file retrieval software 136. However, it will be appreciated that other partitioning of the IoT device's functionality as described herein may be used, in various embodiments.

If the peripheral's address space consists of multiple addresses, these can be expressed in the template description file as an offset from a base address. Under the assumption of “one peripheral attached at time” the software can detect the peripheral's address successfully (detecting attaching of multiple peripheral simultaneously would require additional mechanisms).

As shown at step 5, the IoT device 120 now compiles the template description file, and stores it in a file storage (not shown). This compilation may include, for example, the substitution of actual physical addresses in the peripheral's address space for offsets provided in the template description file.

As shown at steps 6 and 7, the IoT device 120 connects to a server, here illustrated as LwM2M management server 112, and registers the resources it has. This may be done, for example, using the LwM2M registration interface, where the registration comprises registering an IPSO object or objects corresponding to the discovered peripheral device 130. The server is now aware that there is a new peripheral 130, e.g., a temperature sensor, connected to the IoT device 120.

As shown at step 8, the server sends a query to the IoT device 120, the query requesting an exposed peripheral service from the peripheral 130. This query may be, for example, a “GET /3303/0/5700” command, sent to the IoT device 120 using CoAP/LwM2M protocols.

As shown at step 9, the IoT device 120 responds to the query, in this case by executing the requested LwM2M operation on the object, by using the corresponding service description in the compiled template description file to translate the exposed peripheral service into peripheral-specific operations, which are illustrated in FIG. 2 as step 9a. Thus, for example, the IoT device receives the GET command 120 and executes the hardware sequence specified in the service description corresponding to “GET,” as obtained from the template description file. In this case, the sequence of peripheral-specific operations specified by the template description file and included in step 9a might consist of 3 operations: “Acquire I2C Bus”, “Read Peripheral Address”, and “Release I2C Bus”. The sensor in this case receives the I2C read command and responds with the value in the targeted address (e.g., the current temperature), as shown at step 10a. The IoT device 120 receives the sensor response and applies needed conversions, as read from the template description file, to the raw sensor data provided by the sensor, to get an IPSO-object-compatible value (e.g. degrees Celsius). The IoT device 120 fills the answer template obtained from the template description file with the resulting value, to obtain a response message, and sends it to the server 112, as shown at steps 10 and 11.

Alternatively, in step 8 the server 112 may issue a GET request for the full object. In this case, the IoT device 120 may execute multiple operations in step 9, one for each template value present in the service description.

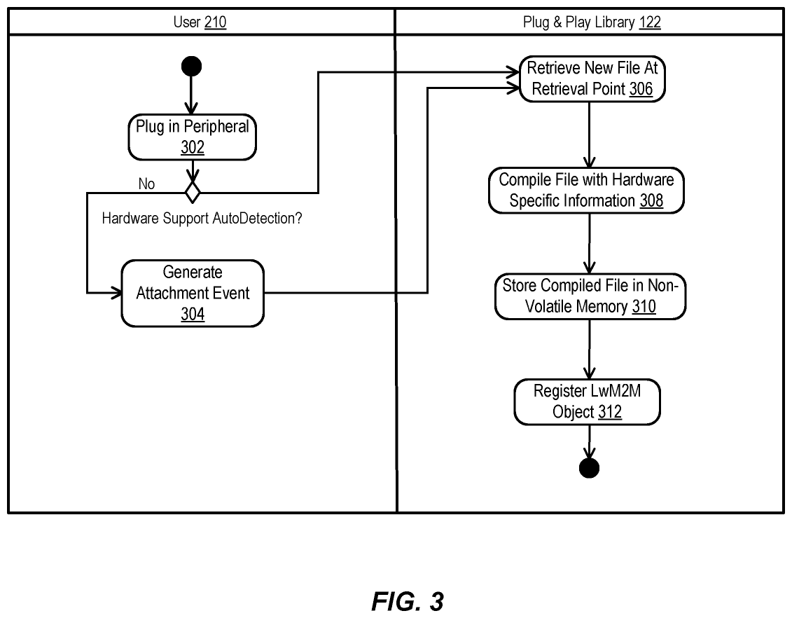

FIG. 3 is a process flow diagram illustrating an example of operations performed during attachment and registration of a new peripheral device 130, in some embodiments. As shown at block 302, the method begins with the plugging in of a new peripheral, e.g., by a user 210. In some cases, the hardware may support automatic detection of the new peripheral, in which case the procedure proceeds directly to the retrieval of the template description file. In other cases, the hardware may not support autodetection, in which case an attachment event may be generated, as shown at block 304, e.g., by the user 210 pressing a button.

As shown at block 306, the software component, here illustrated as plug and play library 122, retrieves the template description file at the defined retrieval point. In some cases, as discussed above, the template description file is stored in and retrieved from memory in the peripheral device itself. In others, the peripheral device 130 may include a stored resource address, such as a URI, pointing the IoT device 120 to a network address from which the template description file may be downloaded. In still others, the template description file may be delivered to the IoT device 120 by other means, e.g., by a user connecting the IoT device 120 to a portable computer or other device and installing the template description file into the IoT device 120.

As shown at block 308, the IoT device 120, via plug and play library 122, then compiles the template description file with hardware-specific information, such as physical addresses corresponding to the peripheral device 130, as connected. This compiled file is then stored in non-volatile memory, as shown at block 310, so that the compiled file can survive power interruptions and/or reboots of the IoT device 120. Then, as shown at block 312, the IoT device 120 can register the newly attached peripheral device with the network-based application. In the illustrated example, the peripheral 130 is registered as a LwM2M object.

Below, an example template description file describes an example temperature sensor, e.g., as used in the previous scenario. In this example, IPSO object data is used to describe the sensor and its functionalities. The template description file also contains the information on how to read the values from the sensor.

Template Description File:

```
OID: 3303;
BT: 12C;
ADDR: BADDR;
OINIT:;
AP:;
RDESC: 5700,0,ResName5700,INT;
ROP:READ
F: RESCALE(0, 512, −273,15, 100);
RINST: BADDR/START/0/0,BADDR,FW/64/INT8,BADDR/SR/0/INT16,BADDR/STOP/0/0;
ROP: WRITE;
F:RESCALE(−273,15,100,0,512);
RINST: BADDR/START/0/0,BADDR,FW/65/INT8,BADDR/IW/50/INT16,BADDR/STOP/0/0;
TRESP:
[
  {“bn” : “3303/”,
    “n” : “5700”, “v” : “$3303/5700/R”},
    {“n” : “5701”, “v” : “Cel”}
]
```

Compiled Description File:

```
OID: 3303;
BT: 0x85;
ADDR: 144;
OINIT:;
AP:;
RDESC: 5700,0,ResName5700,INT;
ROP:READ;
F: RESCALE(0, 512, −273,15, 100);
RINST: 144/START/0/0,144,FW/64/INT8,145/SR/0/INT16,144/STOP/0/0;
ROP: WRITE;
F:RESCALE(−273,15,100,0,512);
RINST: 144/START/0/0, 144,FW/65/INT8, 144/IW/50/INT16, 144/STOP/0/0;
[
  {“bn” : “3303/”,
    “n” : “5700”, “v” : “$3303/5700/R”),
    {“n” : “5701”, “v” : “Cel”}
]
```

In this example, OID: 3303 is an object identifier. BT: I2C is a bus type. ADDR: BADDR is an address used as a template. OINIT is an object initialization. This label identifies a hardware instruction set in the same way the RINST label does. This particular instruction set is defined at object level in order to configure the peripheral after the attachment.

AP is for additional bus parameters. This subset brings information about the whole peripheral. OID associates the hardware to the data model of LwM2M. If another data model is in use, OID still fulfills the purpose of mapping the semantics of a specific application layer data model to the hardware. “BT”, “ADDR”, and “AP” are labels that the device's software needs to substitute using the parameters provided during the “one time per technology” configuration depending on the buses supported and their physical location.

The field RDESC: 5700,0,ResName5700,INT contains the information needed to describe the peripheral components as a LwM2M resource, including the format of the data used during the communication. A resource description is followed by resource instruction sequences, each describing a single resource operation, READ and WRITE in this example. ROP:READ is a resource operation. F: RESCALE(0, 512, −273,15, 100) is an example of formula. Generally a device may provide functionality for attached peripherals through the use of one or more formulas. In this case, the peripheral is asking for a rescale of the range, e.g., from a peripheral-specific range to a standardized range and/or units, and the device is handling the rescaling. This way the footprint of the device code can be more easily managed by deciding what subset of formulas to support for the given domain. Other examples of functionalities that could be commonly needed by peripherals and which could be provided by formulas include decaying windows, rendering of images, averaging a set of values, or transforming between strings and integers.

ROP contains the LwM2M operation associated with this particular Hardware sequence. F contains the formula that needs to be used for converting the data between the hardware representation and the LwM2M representation. RESCALE, as well as other more complex formulas, may be provided to the device with the software component during the one time per technology configuration depending on the purpose and constraints of the device being configured.

The RINST label is given as

BADDR/START/0/0,BADDR,FW/64/INT8,BADDR/SR/0/INT16,BADDR/STOP/0/0. RINST defines the sequence of hardware operation needed to complete the LwM2M operation i.e., the “service description” as described above. START/FW/SR/STOP are all part of a micro-coded language that helps to define the semantics of the operation being executed in order to enable the software to be independent from the actual processor present on the device. START/STOP is to acquire/release a specific bus. FW/IN is to write values to the peripheral (fixed value write/input value write). SR is to read a value from the peripheral (simple read).

TRESP is to define the template response that will be used to communicate with the server. The expression “bn”: “3303/” describes an IPSO temperature sensor (Object ID 3303). The expression “n”: “5700”, “v”: “$3303/5700/R” describes an IPSO resource “sensor value”. It contains the information on which peripheral to read the value. The $ sign signals the beginning of an operation identifier. The line {“n”: “5701”, “v”: “Cel”} describes a fixed IPSO resource “Units”.

Note that the hardware description provided with the description template file is position dependent. After each RDESC, it is expected to find multiple ROP/F/RINST, one for each operation defined by the application layer data model, i.e., for each exposed peripheral service.

The micro-codes used to define the hardware operation paired with the one time per technology configuration help the software running on the device to stay processor independent, while at the same time enabling manufacturers of peripheral to “reuse” their own files shrinking the effort needed going further.

The Function/Formula applies differently for each hardware instruction set depending on the operation. For reads, it is applied after the instruction set has been executed and the value retrieved. For writes, it is applied before executing the instruction set. In this way, consistency between the hardware representation and the target data model can be achieved.

The template description file and peripheral need not to reside on the same bus/component. Using the One Time per Technology configuration the file can be stored elsewhere. The key assumption is that the file retrieval operation will always retrieve the description file of the last attached peripheral, while the compiled description file contains all the already attached ones.

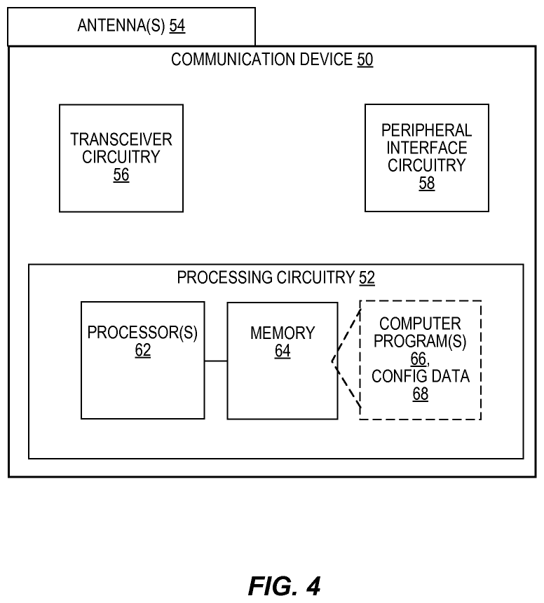

FIG. 4 illustrates a diagram of a communication device 50 configured to carry out one or more of the disclosed techniques described for an IoT device, according to some embodiments.

Communication device 50 may be considered to represent or include an IoT device, such as IoT device 120 or similar device, in a wireless network or in some type of IoT platform.

Communication device 50 is configured to communicate with the network or IoT platform via a network interface. In the illustrated embodiment, this network interface is shown as transceiver circuitry 56, which communicates with a wireless network via antennas 54. The transceiver circuitry 56 may include transmitter circuits, receiver circuits, and associated control circuits that are collectively configured to transmit and receive signals according to a radio access technology, for the purposes of using wireless communication services, whether local, cellular or otherwise. It will be appreciated that the presently disclosed techniques are not limited to use in wireless communication devices, but may also be used in communication devices that connect to a communications network via wired means.

Communication device 50 also includes one or more processing circuits 52 that are operatively associated with transceiver circuitry 56. Processing circuitry 52 comprises one or more digital processing circuits 62, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, processing circuitry 52 may comprise fixed circuitry, or programmable circuitry that is specially adapted via the execution of program instructions implementing the functionality taught herein, or may comprise some mix of fixed and programmed circuitry. Processing circuitry 52 may be multi-core.

Processing circuitry 52 also includes a memory 64. Memory 64, in some embodiments, stores one or more computer programs 66 and, optionally, configuration data 68. Memory 64 provides non-transitory storage for computer program 66 and it may comprise one or more types of computer-readable media, such as disk storage, solid-state memory storage, or any mix thereof. By way of non-limiting example, memory 64 comprises any one or more of SRAM, DRAM, EEPROM, and FLASH memory, which may be in processing circuitry 52 and/or separate from processing circuitry 52. Memory 64 may also store any configuration data 68 used by communication device 50. Processing circuitry 52 may be configured, e.g., through the use of appropriate program code stored in memory 64, to carry out one or more of the methods and/or signaling processes detailed hereinafter.

Processing circuitry 52 of communication device 50 is configured, according to some embodiments, to allow attachment of one or more peripheral devices. The processing circuitry is configured to detect attachment of a peripheral device and obtain a template description file for the peripheral device, the template description file comprising one or more service descriptions corresponding to respective exposed peripheral services, each service description defining one or more peripheral-specific operations. The processing circuitry 52 is also configured to receive, from a network-based application, a query directed to the peripheral device, the query requesting one of the exposed peripheral services. The processing circuitry 52 is configured to execute the one or more peripheral-specific operations from the service description corresponding to the requested one of the exposed peripheral services and respond to the network-based application with a result of the one or more peripheral-specific operations.

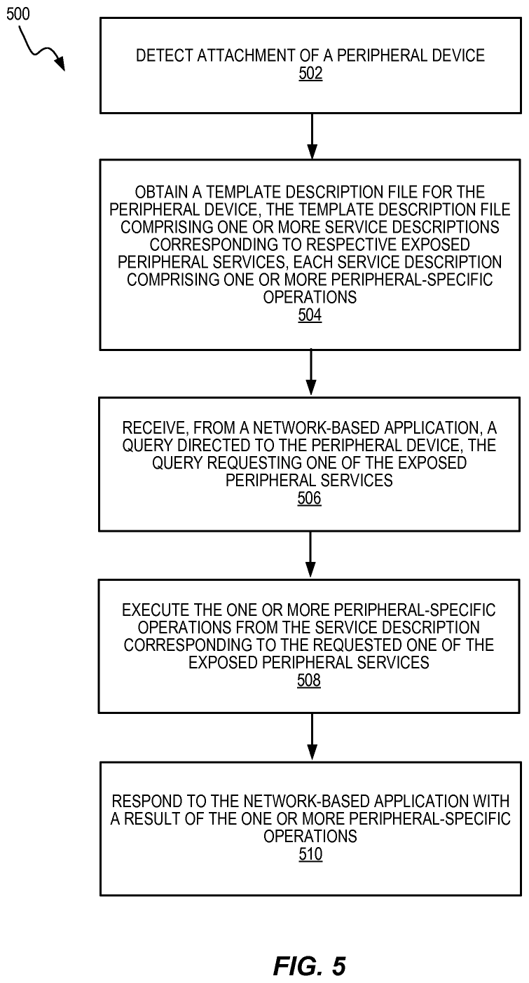

According to some embodiments, processing circuitry 52 is configured to perform a method 500 for allowing attachment of one or more peripheral devices. The method 500 is shown in FIG. 5 and includes detecting attachment of a peripheral device (block 502). This can include use of a push-button or another method, such as near-field communication (NFC). The method 500 also includes obtaining a template description file for the peripheral device (block 504). The template description file includes one or more service descriptions corresponding to respective exposed peripheral services, where each service description defines one or more peripheral-specific operations. The template description file may be located in the peripheral device or in other file storage, including in cloud storage. The method 500 further includes receiving, from a network-based application, a query directed to the peripheral device, the query requesting one of the exposed peripheral services (block 506). The method 500 also includes executing the one or more peripheral-specific operations from the service description corresponding to the requested one of the exposed peripheral services (block 508) and responding to the network-based application with a result of the one or more peripheral-specific operations (block 510).

In some embodiments, obtaining the template description file for the peripheral device includes retrieving the template description file from a memory in the peripheral device. In other embodiments, obtaining the template description file for the peripheral device includes retrieving a resource address from a memory in the peripheral device and retrieving the template description file from a network location specified by the resource address.

The exposed peripheral services may be standardized operations according to any of: OMA SpecWorks standard, Open Connectivity Foundation (OCF) standard and Fairhair Alliance, etc. standards.

The method 500 may further include, prior to receiving the query, registering the peripheral device with a management server. The management server may be an OMA Lightweight M2M (LwM2M) management server, and the registering may include registering the peripheral device as a LwM2M client.

In some embodiments, the method 500 includes, prior to receiving said query, compiling the template description file, where the compiling includes assigning a base address to the peripheral device and assigning one or more operation addresses to respective ones of the peripheral-specific operations, based on address offsets included in the template description file. The method 500 may further include storing the compiled template description file in non-volatile memory, where executing the one or more peripheral-specific operations from the service description includes retrieving the peripheral-specific operations for execution from the stored, compiled, template description file. The method 500 may further includes performing an integrity and authentication check of the template description file, prior to the compiling.

In some embodiments, the method 500 includes inserting the result into a template answer obtained from the template description file, to produce a response message, and responding to the network-based application with the response message.

As discussed in detail above, the techniques described herein, e.g., as illustrated in the process flow diagrams of FIG. 5, may be implemented, in whole or in part, using computer program instructions executed by one or more processors. It will be appreciated that a functional implementation of these techniques may be represented in terms of functional modules, where each functional module corresponds to a functional unit of software executing in an appropriate processor or to a functional digital hardware circuit, or some combination of both.

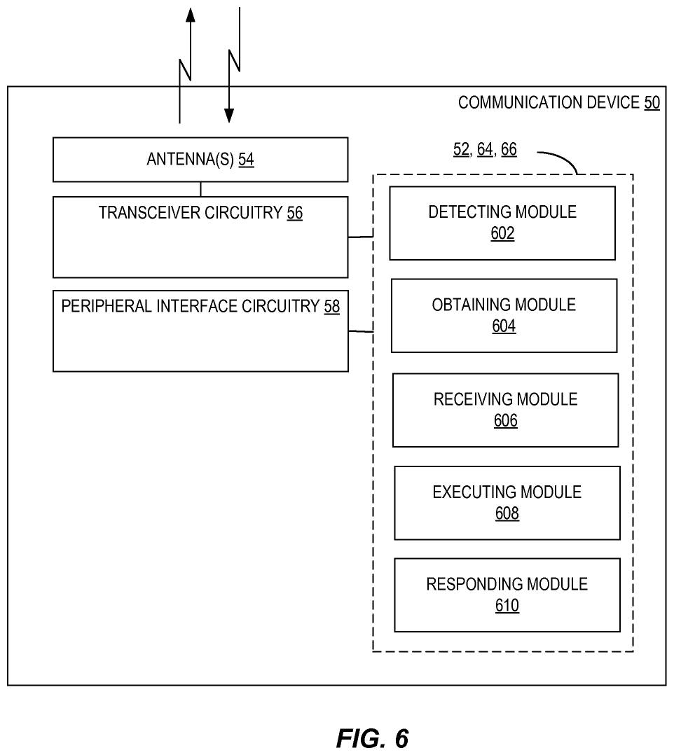

FIG. 6 illustrates an example of functional modules or circuit architecture in communication device 50 for allowing attachment of one or more peripheral devices. The functional implementation includes a detecting module 602 for detecting attachment of a peripheral device and an obtaining module 604 for obtaining a template description file for the peripheral device, the template description file comprising one or more service descriptions corresponding to respective exposed peripheral services, each service description comprising one or more peripheral-specific operations. The implementation also includes a receiving module 606 for receiving, from a network-based application, a query directed to the peripheral device, the query requesting one of the exposed peripheral services. The implementation includes an executing module 608 for executing the one or more peripheral-specific operations from the service description corresponding to the requested one of the exposed peripheral services and a responding module 610 for responding to the network-based application with a result of the one or more peripheral-specific operations.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1-24. (canceled)

25. A method, in a communications device configured to allow attachment of one or more peripheral devices, the method comprising:
detecting attachment of a peripheral device;
obtaining a template description file for the peripheral device, the template description file comprising one or more service descriptions corresponding to respective exposed peripheral services, each service description comprising one or more peripheral-specific operations;
receiving, from a network-based application, a query directed to the peripheral device, the query requesting one of the exposed peripheral services;
executing the one or more peripheral-specific operations from the service description corresponding to the requested one of the exposed peripheral services; and
responding to the network-based application with a result of the one or more peripheral-specific operations.

26. The method of claim 25, wherein obtaining the template description file for the peripheral device comprises retrieving the template description file from a memory in the peripheral device.

27. The method of claim 25, wherein obtaining the template description file for the peripheral device comprises retrieving a resource address from a memory in the peripheral device and retrieving the template description file from a network location specified by the resource address.

28. The method of claim 25, wherein the exposed peripheral services are standardized operations according to any of: OMA SpecWorks standard, Open Connectivity Foundation (OCF) standard, and Fairhair Alliance standard.

29. The method of claim 25, wherein the method further comprises, prior to receiving said query, registering the peripheral device with a management server.

30. The method of claim 29, wherein the management server is an OMA Lightweight M2M (LwM2M) management server, and wherein said registering comprises registering the peripheral device as a LwM2M client.

31. The method of claim 25, wherein the method further comprises, prior to receiving said query, compiling the template description file, wherein said compiling comprises assigning a base address to the peripheral device and assigning one or more operation addresses to respective ones of the peripheral-specific operations, based on address offsets included in the template description file.

32. The method of claim 31, wherein the method further comprises storing the compiled template description file in non-volatile memory, wherein said executing the one or more peripheral-specific operations from the service description comprises retrieving the peripheral-specific operations for execution from the stored, compiled, template description file.

33. The method of claim 31, wherein the method further comprises performing an integrity and authentication check of the template description file, prior to said compiling.

34. The method of claim 25, wherein the method comprises inserting the result into a template answer obtained from the template description file, to produce a response message, and responding to the network-based application with the response message.

35. A communications device, comprising:
a network interface configured to communicate with a communication network;
a peripheral interface configured to allow attachment of one or more peripheral devices to the communications device;
a processing circuit operatively coupled to the network interface and the peripheral interface; and
a memory operatively coupled to the processing circuit and comprising program code for execution by the processing circuit, whereby the processing circuit is configured to:
detect attachment of a peripheral device;
obtain a template description file for the peripheral device, the template description file comprising one or more service descriptions corresponding to respective exposed peripheral services, each service description comprising one or more peripheral-specific operations;
receive, from a network-based application, a query directed to the peripheral device, the query requesting one of the exposed peripheral services;
execute the one or more peripheral-specific operations from the service description corresponding to the requested one of the exposed peripheral services; and
respond to the network-based application with a result of the one or more peripheral-specific operations.

36. The communications device of claim 35, wherein the processing circuit is configured to obtain the template description file for the peripheral device by retrieving the template description file from a memory in the peripheral device.

37. The communications device of claim 35, wherein the processing circuit is configured to obtain the template description file for the peripheral device by retrieving a resource address from a memory in the peripheral device and retrieving the template description file from a network location specified by the resource address.

38. The communications device of claim 35, wherein the exposed peripheral services are standardized operations according to any of: OMA SpecWorks standard, Open Connectivity Foundation (OCF) standard, and Fairhair Alliance standard.

39. The communications device of claim 35, wherein the processing circuit is further configured to, prior to receiving said query, register the peripheral device with a management server.

40. The communications device of claim 39, wherein the management server is an OMA Lightweight M2M (LwM2M) management server, and wherein said registering comprises registering the peripheral device as a LwM2M client.

41. The communications device of claim 35, wherein the processing circuit is further configured to, prior to receiving said query, compile the template description file, wherein said compiling comprises assigning a base address to the peripheral device and assigning one or more operation addresses to respective ones of the peripheral-specific operations, based on address offsets included in the template description file.

42. The communications device of claim 41, wherein the processing circuit is further configured to store the compiled template description file in non-volatile memory and is further configured to retrieve the peripheral-specific operations for execution from the stored, compiled, template description file.

43. The communications device of claim 41, wherein the processing circuit is further configured to perform an integrity and authentication check of the template description file, prior to said compiling.

44. The communications device of claim 35, wherein the processing circuit is further configured to insert the result into a template answer obtained from the template description file, thereby producing a response message, and to respond to the network-based application with the response message.

45. A non-transitory computer-readable medium comprising, stored thereupon, a computer program product comprising instructions that, when executed on at least one processing circuit, cause the at least one processing circuit to carry out a method according to claim 25.
